(19) United States
(12) Patent Application Publication
(10) Pub. No.: US 2018/0217302 A1
(43) Pub. Date: Aug. 2, 2018

(54) Prism Sheet and Method for Producing the Same, Backlight Module and VR Display Apparatus

(71) Applicants: BOE Technology Group Co., Ltd, Beijing (CN); BOE Optical Science and Technology Co., Ltd., Suzhou (CN)

(72) Inventor: Jialuo Chen, Beijing (CN)

(21) Appl. No.: 15/567,868

(22) PCT Filed: Apr. 17, 2017
(86) PCT No.: PCT/CN2017/080753

§ 371 Date: Oct. 19, 2017

(30) Foreign Application Priority Data
Apr. 26, 2016 (CN) 201610267140.4

(51) Int. Cl. G02B 5/04

(52) U.S. Cl. CPC G02B 5/045

(57) ABSTRACT

The present application discloses a prism sheet and a method for producing the same, a backlight module and a VR display apparatus. The prism sheet includes a substrate which has a light incidence surface and a light exit surface, the light incidence surface and the light exit surface being respectively arranged on a first side and a second side of the substrate opposed to each other, a plurality of pits are provided on the light incidence surface and spaced apart from each other, and each of the pits includes an opening portion, a bottom portion and an inclined wall portion connecting the opening portion with the bottom portion, the opening portion forming an opening which has an area greater than the area of the bottom portion of the pit.

### CROSS-REFERENCE TO RELATED APPLICATION

This application claims benefit of the Chinese Patent Application No. 201610267140.4, filed with the State Intellectual Property Office of China on Apr. 26, 2016, which is incorporated herein by reference in its entirety.

### BACKGROUND OF THE DISCLOSURE

### Field of the Disclosure

The present application relates to the technical field of display, and in particular, to a prism sheet, a method for producing the prism sheet, a backlight module and a VR display apparatus.

### Description of the Related Art

A VR display apparatus, also called as virtual reality display apparatus, uses virtual reality (abbreviated as VR) technology in the display apparatus such that the user can be immersed in a three-dimensional dynamical visual scene environment and human computer interaction between the user and the VR display apparatus can be implemented. In this way, the user will be totally immersed in the scene.

In general, lens between a display screen in the VR display apparatus and human eyes has a larger area with respect to the area of the display screen. In this way, the light exit direction of an image displayed on the display screen can be adjusted to reduce distortion in the image seen by the user such that the user can see a vivid image. Such method for reducing the distortion in the image seen by the user must increase the area of lens in the VR display apparatus.

### SUMMARY

An embodiment of the present disclosure provides a prism sheet, including a substrate which has a light incidence surface and a light exit surface, the light incidence surface and the light exit surface being respectively arranged on a first side and a second side of the substrate opposed to each other, wherein a plurality of pits are provided on the light incidence surface and spaced apart from each other, and each of the pits includes an opening portion, a bottom portion and an inclined wall portion connecting the opening portion with the bottom portion, an opening which is formed by the opening portion has an area greater than the area of the bottom portion of the pit.

In an embodiment, a plane in which the opening portion of the pit is arranged is at an angle α of 10 degrees to 70 degrees with respect to the inclined wall portion.

In an embodiment, the opening portion has a shape of circle or polygon.

In an embodiment, the opening portion has a shape of circle and each pit is a circular cone-shaped pit or a circular truncated cone-shaped pit.

In an embodiment, the opening portion of the circular cone-shaped pit has a diameter of 0.005 mm to 0.1 mm and the circular cone-shaped pit has a depth of 0.005 mm to 0.1 mm; or the opening portion of the circular truncated cone-shaped pit has a diameter of 0.01 mm to 0.1 mm and the circular truncated cone-shaped pit has a bottom diameter of 0.005 mm to 0.09 mm and a depth of 0.005 mm to 0.1 mm.

In an embodiment, the opening portion has a shape of polygon and each pit is a pyramid-shaped pit.

In an embodiment, the pyramid-shaped pit is a regular pyramid-shaped pit; the opening portion of the regular pyramid-shaped pit has a side length of 0.005 mm to 0.1 mm and the regular pyramid-shaped pit has a depth of 0.005 mm to 0.1 mm.

In an embodiment, a distance between central axes of adjacent pits is 0.005 mm to 0.1 mm.

In an embodiment, all of the pits are provided on the light incidence surface of the substrate in hexagonal close-packed arrangement or in square arrangement.

An embodiment of the present disclosure also provides a method for producing the prism sheet as described in any one of the above embodiments, the method including: providing a die with a plurality of protrusions and forming a plurality of pits on a substrate by using the protrusions on the die to finish production of the prism sheet.

In an embodiment, the die is a roller and the plurality of protrusions are provided on a surface of the roller; and the forming the plurality of pits on the substrate by using the protrusions on the die includes: forming a photosensitive resist coating on a first side of the substrate; driving the roller to roll over the photosensitive resist coating to transfer a pattern formed by the protrusions on the roller onto the photosensitive resist coating to form the plurality of pits in the photosensitive resist coating; and photo curing the photosensitive resist coating formed with the plurality of pits to form the prism sheet.

In an embodiment, the forming the plurality of pits on the substrate by using the protrusions on the die includes: forming the prism sheet in the die by an injection molding process; or heating the die to a target temperature and placing the substrate into the die to form the pits on locations of the substrate which contact with the protrusions, so as to obtain the prism sheet.

An embodiment of the present disclosure also provides a backlight module including the prism sheet as described in any one of the above embodiments.

An embodiment of the present disclosure also provides a VR display apparatus including the backlight module as described in any one of the above embodiments.

### BRIEF DESCRIPTION OF THE DRAWINGS

Figures illustrated herein are intended for further understanding the present application and constitute a part of the present application. Exemplified embodiments and their explanations of the present application are intended to interpret the present application, instead of forming inappropriate limitations to the present application.

FIG. 1 is a schematic view showing a first prism sheet according to an embodiment of the present application;

FIG. 2 is a schematic cross sectional view of the first prism sheet shown in FIG. 1, taken along a line A-A;

FIG. 3 is a schematic perspective view showing a pit in FIG. 1;

FIG. 4 is a top view showing a second prism sheet according to an embodiment of the present application;

FIG. 5 is a schematic cross sectional view of the second prism sheet shown in FIG. 4, taken along a line A-A;

FIG. 6 is a schematic perspective view showing a pit in FIG. 4;

FIG. 7 is a top view showing a third prism sheet according to an embodiment of the present application;

FIG. 8 is a schematic cross sectional view of the third prism sheet shown in FIG. 7, taken along a line A-A;

FIG. 9 is a schematic perspective view showing a pit in FIG. 7;

FIG. 10 is a three dimensional schematic view showing a light distribution curve of a backlight module provided with the first prism sheet provided in FIG. 1 and the second prism sheet provided in FIG. 4;

FIG. 11 is a three dimensional schematic view showing a light distribution curve of a backlight module provided with the third prism sheet provided in FIG. 7;

FIG. 12 schematically shows use of a prism sheet according to an embodiment of the present application in a backlight module;

FIG. 13 schematically shows an exemplified die for producing a prism sheet according to an embodiment of the present application; and

FIG. 14 schematically shows another exemplified die for producing a prism sheet according to an embodiment of the present application.

### DETAILED DESCRIPTION OF PREFERRED EMBODIMENTS OF THE DISCLOSURE

In order to further explain the prism sheet, the method for producing the same, the backlight module and the VR display apparatus provided by the embodiments of the present application, the exemplified embodiments of the present disclosure will below be explained in detail with reference to the accompanied drawings.

In accordance with a general concept, an embodiment of the present disclosure provides a prism sheet including a substrate which has a light incidence surface and a light exit surface, the light incidence surface and the light exit surface being respectively arranged on a first side and a second side of the substrate opposed to each other, wherein a plurality of pits are provided on the light incidence surface and spaced apart from each other, and each of the pits includes an opening portion, a bottom portion and an inclined wall portion connecting the opening portion with the bottom portion, the opening portion forming an opening which has an area greater than the area of the bottom portion of the pit.

In addition, in the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

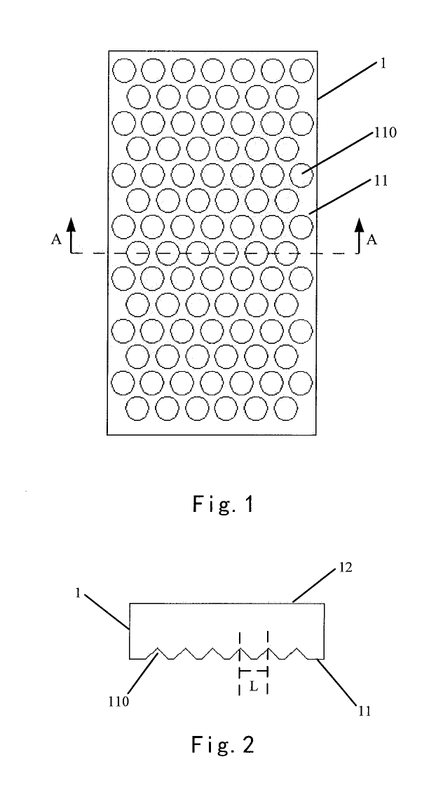

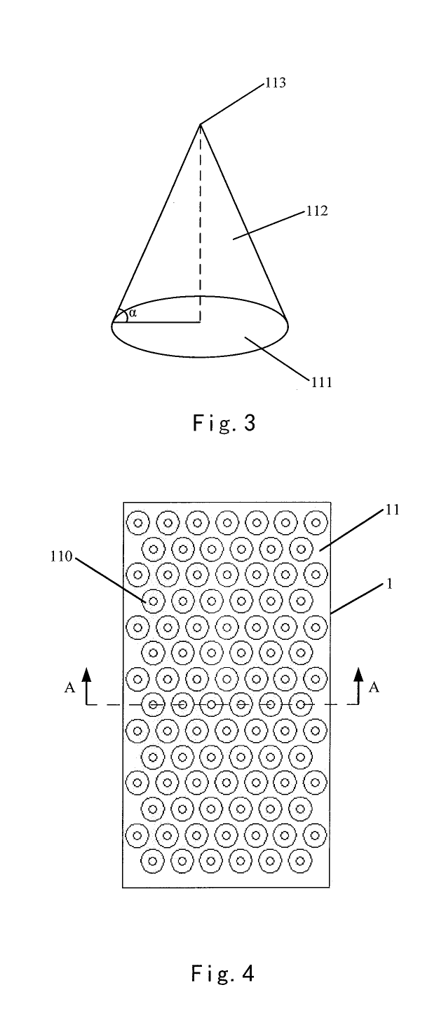

As illustrated in FIG. 1 to FIG. 6, a prism sheet provided by an embodiment of the present application includes a substrate 1 which has a light incidence surface 11 and a light exit surface 12. The light incidence surface 11 is arranged on a first side of the substrate 1. The light exit surface 12 is arranged on a second side of the substrate 1. The first side and the second side of the substrate 1 are opposed to each other. A plurality of pits 110 are provided on the light incidence surface 11 of the substrate 1 and spaced apart from each other. As illustrated in FIG. 3, FIG. 6 and FIG. 9, each of the pits 110 includes an opening portion 111, a bottom portion 113 and an inclined wall portion 112 connecting the opening portion 111 with the bottom portion 113. The opening portion 111 forms an opening which has an area greater than the area of the bottom portion 113 of the pit.

In a light transmission, the light is incident onto the light incidence surface 11 of the substrate 1 and exits from the light exit surface 12.

Specifically, the light enters the pit 110 from the opening portion 111 of the pit 110 and is reflected at multiple times by the inclined wall portion 112 of the pit 110, and finally refracted from the inclined wall portion 112 or from the bottom portion 113 of the pit 110. Ultimately, the light exits from the light exit surface 12 of the substrate 1.

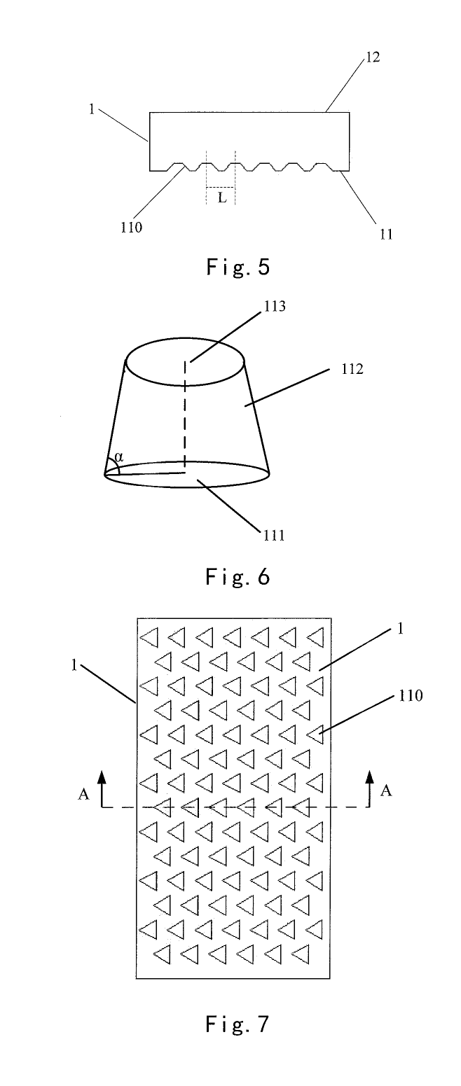

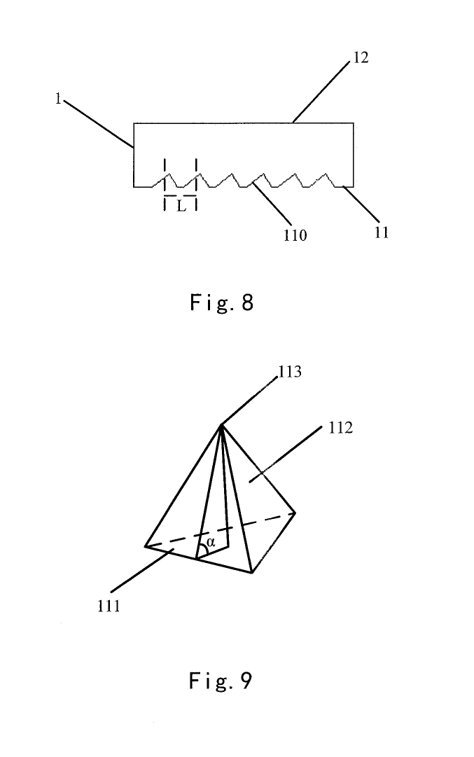

As an example, the pits 110 have a pitch L, as shown in FIG. 2, FIG. 5 and FIG. 8.

From the light transmission process provided in the above embodiment, it can be known that in the prism sheet provided by the present embodiment, the light incidence surface 11 of the substrate 1 is provided with a plurality of pits 110 and the opening portion of each pit 110 is connected to the bottom portion 113 of the pit by the inclined wall portion 112. When the light enters the substrate 1 from the light incidence surface 11 of the substrate 1, the light can enter each pit 110 and be reflected at multiple times by the inclined wall portion 112 of the pit 110 and finally exit from the light exit surface 12 of the substrate 1 by refraction. Also, as the area of the opening formed by the opening portion 111 of the pit 110 is greater than the area of the bottom portion 113 of the pit, the pit 10 is formed in a gradually shrunk manner from the opening portion 111 to the bottom portion 113. In this way, not only the light can be refracted or reflected at multiple times at the inclined wall portion 112 of the pit 110, but also the light exit direction can be controlled by the orientation in which the pit 110 is shrunk gradually. By using such prism sheet in a backlight module of a VR display apparatus, the backlight module may provide a backlight having good directionality to a display screen, so as to adjust the exit light from an image displayed on the display screen instead of increasing the area of the lens with respect to the display screen in the VR display apparatus excessively, that is, distortion of the image seen by the user may be reduced. It not only can improve immersive experiences of the user from the VR display apparatus, but also can reduce volume of the VR display apparatus to some extent to achieve wearable VR display apparatus as it is not required to increase the area of the lens with respect to the display screen in the VR display apparatus excessively.

It should be noted that the substrate 1 in the above embodiment may be a thin film or a board; in general, when the substrate 1 is in form of the thin film, it may be a polyester thin film or a plastic thin film, but it is not limited to this; when the substrate 1 is a board, it may be a plastic board, but it is not limited to this.

In the above embodiments, the pit 110 may have various shapes, however, anyway, the shrinking direction of the pit 110 is determined by an angle α between the opening portion and the inclined wall portion 112 in the above embodiments. For different angles α, the pits may have different shrinking directions. Correspondingly, the prism sheet is provided behind the backlight module and can control the exit direction of the light.

In consideration of application of the prism sheet, a plane in which the opening portion of the pit 110 is arranged is at an inclination angle α of 10 degrees to 70 degrees with respect to the inclined wall portion 112. In particular, in the above embodiments, the opening formed by the opening portion 111 of the pit 110 may have a shape of circle or polygon.

As an example, when the opening is circular, each pit 110 may be a circular cone-shaped pit or a circular truncated cone-shaped pit.

FIG. 3 shows a circular cone-shaped pit schematically by one circular cone. The cone bottom of the circular cone represents the opening portion 111 of the circular cone-shaped pit. The conical surface of the circular cone represents the inclined wall portion 112 of the circular cone-shaped pit. The cone apex of the circular cone represents the bottom portion 113 of the circular cone-shaped pit. When each pit 110 is the circular cone pit, the bottom portion 113 of the pit has a point-like structure. And the inclination angle α between the plane in which the opening portion of the pit 110 is located and the inclined wall portion 112 is the angle between the conical surface and the cone bottom of the circular cone, that is,

$$tg α = \frac{2 h}{d} .$$

From the above equation

$$tg α = \frac{2 h}{d} ,$$

it can be determined the angle depends on the ratio of the diameter d of the opening portion of the circular cone-shaped pit to the depth h of the circular cone-shaped pit. If the diameter d of the opening portion of the circular cone-shaped pit has been determined, the depth h of the circular cone-shaped pit will be limited by the inclination angle α.

For example, the opening portion of the circular cone-shaped pit has a diameter d of 0.005 mm to 0.1 mm and the circular cone-shaped pit has a depth h of 0.005 mm to 0.1 mm.

If α=10° and the opening portion of the circular cone-shaped pit has the diameter d of 0.08 mm, the depth h of the circular cone-shaped pit will be 0.01 mm.

If α=45° and the opening portion of the circular cone-shaped pit has the diameter d of 0.01 mm, the depth h of the circular cone-shaped pit will be 0.005 mm.

If α=60° and the opening portion of the circular cone-shaped pit has the diameter d of 0.1 mm, the depth h of the circular cone-shaped pit will be 0.0866 mm.

If α=65° and the opening portion of the circular cone-shaped pit has the diameter d of 0.0933 mm, the depth h of the circular cone-shaped pit will be 0.1 mm.

If α=70° and the opening portion of the circular cone-shaped pit has the diameter d of 0.005 mm, the depth h of the circular cone-shaped pit will be 0.0069 mm.

FIG. 6 shows a circular truncated cone-shaped pit schematically by one circular truncated cone. The lower bottom surface of the circular truncated cone represents the opening portion 111 of the circular truncated cone-shaped pit. The side surface of the circular truncated cone represents the inclined wall portion 112 of the circular truncated cone-shaped pit. The upper bottom surface of the circular truncated cone represents the bottom portion 113 of the circular truncated cone-shaped pit. When each pit 110 is the circular truncated cone pit, the bottom portion 113 of the pit has a plane-like structure. And the inclination angle α between the plane in which the opening portion of the pit 110 is located and the inclined wall portion 112 is the angle between the side surface and the lower bottom surface of the circular truncated cone, that is,

$$tg α = \frac{2 h}{d 1 - d 2} .$$

From the above equation

$$tg α = \frac{2 h}{d 1 - d 2} ,$$

it can be determined the angle depends on the diameter d1 of the opening portion of the circular truncated cone-shaped pit, the diameter d2 of the bottom portion of the circular truncated cone-shaped pit and the depth h of the circular truncated cone-shaped pit. If the depth h of the circular truncated cone-shaped pit has been determined, a difference between the diameter d1 of the opening portion and the diameter d2 of the bottom portion of the circular truncated cone-shaped pit will be limited by the inclination angle α.

For example, the opening portion of the circular truncated cone-shaped pit has a diameter d1 of 0.01 mm to 0.1 mm, the bottom portion of the circular truncated cone-shaped pit has a diameter d2 of 0.005 mm to 0.09 mm, and the circular truncated cone-shaped pit has a depth h of 0.005 mm to 0.1 mm.

If α=10° and the depth h of the circular truncated cone-shaped pit is 0.00838 mm, the opening portion of the circular truncated cone-shaped pit will have the diameter d1 of 0.1 mm and the bottom portion of the circular truncated cone-shaped pit will have the diameter d2 of 0.005 mm.

If α=30° and the depth h of the circular truncated cone-shaped pit is 0.0274 mm, the opening portion of the circular truncated cone-shaped pit will have the diameter d1 of 0.1 mm and the bottom portion of the circular truncated cone-shaped pit will have the diameter d2 of 0.005 mm.

If α=45° and the depth h of the circular truncated cone-shaped pit is 0.005 mm, the opening portion of the circular truncated cone-shaped pit will have the diameter d1 of 0.1 mm and the bottom portion of the circular truncated cone-shaped pit will have the diameter d2 of 0.09 mm.

If α=60° and the depth h of the circular truncated cone-shaped pit is 0.01 mm, the opening portion of the circular truncated cone-shaped pit will have the diameter d1 of 0.0415 mm and the bottom portion of the circular truncated cone-shaped pit will have the diameter d2 of 0.03 mm.

If α=65° and the depth h of the circular truncated cone-shaped pit is 0.00536 mm, the opening portion of the circular truncated cone-shaped pit will have the diameter d1 of 0.01 mm and the bottom portion of the circular truncated cone-shaped pit will have the diameter d2 of 0.005 mm.

If α=70° and the depth h of the circular truncated cone-shaped pit is 0.1 mm, the opening portion of the circular truncated cone-shaped pit will have the diameter d1 of 0.09 mm and the bottom portion of the circular truncated cone-shaped pit will have the diameter d2 of 0.0172 mm.

As an example, when the opening portion has a shape of polygon, each pit 110 is a pyramid-shaped pit or a prismoid-shaped pit.

FIG. 9 shows a pyramid-shaped pit schematically by one pyramid. The bottom of the pyramid represents the opening portion 111 of the pyramid-shaped pit. The side surface of the pyramid represents the inclined wall portion 112 of the pyramid-shaped pit. The apex of the pyramid-shaped pit represents the bottom portion 113 of the pyramid-shaped pit. Taking the pyramid-shaped pit as an example, the bottom portion 113 of the pit has a plane-like structure. And the inclination angle α between the plane in which the opening portion of the pit 110 is located and the inclined wall portion 112 is the angle between the bottom of the pyramid and the side surface of the pyramid. The angle depends on the specific structure of the pyramid-shaped pit and the side length of the opening portion of the pyramid-shaped pit and the depth of pyramid-shaped pit. For example, when the pyramid-shaped pit is a regular pyramid-shaped pit, the opening portion of the regular pyramid-shaped pit has a side length a of 0.005 mm to 0.1 mm and the regular pyramid-shaped pit has a depth h of 0.005 mm to 0.1 mm.

If the regular pyramid-shaped pit is a tri-pyramid-shaped pit, as shown in FIG. 9, the inclination angle α will be determined as

$$tg α = \frac{2 \sqrt{3} h}{a} .$$

The relationship between the inclination angle α and the side length a of the opening portion of the tri-pyramid-shaped pit and the depth h of the tri-pyramid-shaped pit will below be explained with reference to figures.

If α=10° and the side length a of the opening portion of the tri-pyramid-shaped pit is 0.098 mm, the depth h of the tri-pyramid-shaped pit will be 0.005 mm.

If α=30° and the side length a of the opening portion of the tri-pyramid-shaped pit is 0.1 mm, the depth h of the tri-pyramid-shaped pit will be 0.0167 mm.

If α=45° and the side length a of the opening portion of the tri-pyramid-shaped pit is 0.0173 mm, the h depth of the tri-pyramid-shaped pit will be 0.005 mm.

If α=60° and the side length a of the opening portion of the tri-pyramid-shaped pit is 0.05 mm, the depth h of the tri-pyramid-shaped pit will be 0.025 mm.

If α=70° and the side length a of the opening portion of the tri-pyramid-shaped pit is 0.007 mm, the depth h of the tri-pyramid-shaped pit will be 0.0056 mm.

If α=70° and the side length a of the opening portion of the tri-pyramid-shaped pit is 0.1 mm, the depth h of the tri-pyramid-shaped pit will be 0.08 mm.

In addition, in order to show the influence of the prism sheet on an output light intensity distribution of the backlight module (for example, may be represented by a luminous intensity distribution curve) with different shapes of the pit 110, the luminous intensity distribution curve of the backlight module that is provided with the prism sheet provided by the above embodiments is measured.

The following examples will be given in accordance with the shapes of pits in the prism sheet provided by the above embodiments:

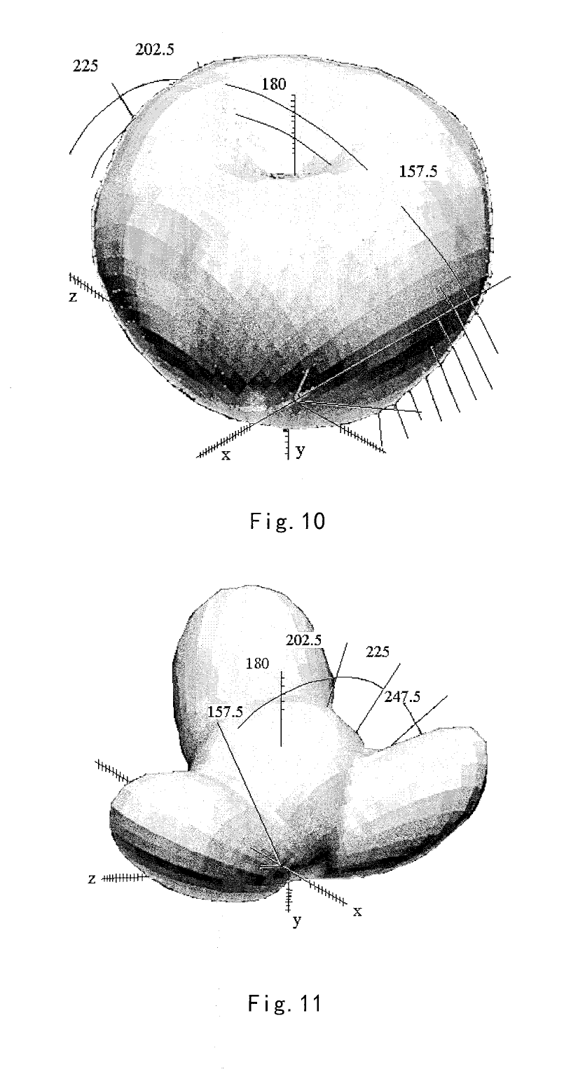

First example: the fit 110 in the prism sheet is a circular cone-shaped pit or a circular truncated cone-shaped pit with the inclination angle of 45°. As such fit has the inclined wall portion 112 which is symmetrical with respect to a central axis of the circular cone-shaped pit or the circular truncated cone-shaped pit, the light having passed through the prism sheet is also symmetrical. In this way, the luminous intensity distribution curve of the backlight module is distributed symmetrically after such prism sheet is used in the backlight module. FIG. 10 shows an example of a three dimensional diagram of the luminous intensity distribution curve of the backlight module in which such prism sheep is applied. Seen from FIG. 10, when the fit 110 in the prism sheet is the circular cone-shaped pit or the circular truncated cone-shaped pit, the luminous intensity distribution curve of the backlight module is distributed in rotational symmetry. It also proves the influence of the shapes of the fit on the luminous intensity distribution curve of the backlight module, by experiments.

Second example: the fit 110 in the prism sheet is a tri-pyramid-shaped pit with the inclination angle of 45°. The prism sheet is applied on a light exit surface of a light guide plate of the backlight module. FIG. 11 shows the test result of the luminous intensity distribution curve of the backlight module. Seen from FIG. 11, when the fit 110 in the prism sheet is the tri-pyramid-shaped pit, the luminous intensity distribution curve of the backlight module is distributed in non-bilateral symmetry. And the non-bilateral symmetry of the luminous intensity distribution curve of the backlight module corresponds to the non-bilateral symmetry of tri-pyramid-shaped pit, that is, the tri-pyramid-shaped pit is in triple rotational symmetry, and thus the luminous intensity distribution curve of the backlight module is also in triple rotational symmetry. In addition, from many experiments, it can be found that if the pyramid-shaped pit is an n-fold rotational symmetrical structure, the luminous intensity distribution curve of the backlight module will also have an n-folded rotational symmetrical shape; if the pyramid-shaped pit is a non-rotational symmetrical structure, the luminous intensity distribution curve of the backlight module will also have a non-rotational symmetrical shape.

By analyzing the above measuring results, it can be determined that the luminous intensity distribution curve of the backlight module can be controlled to vary by defining the shape and parameters of the fits on the prism sheet. Thus, in practical applications, the prism sheet may be selected for the backlight module depending on the requirements of the luminous intensity distribution curve.

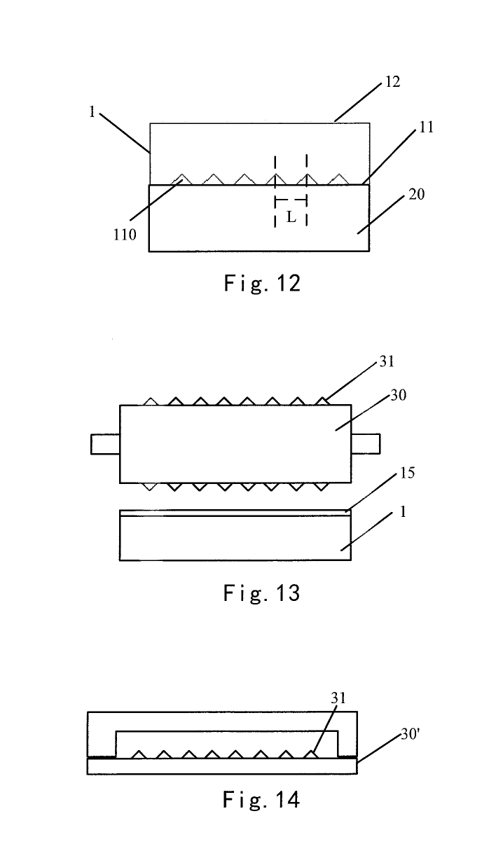

In addition, as illustrated in FIG. 12, when the prism sheet provided by the above embodiment is applied in the backlight module, the light incidence surface 11 of the prism sheet faces towards a light exit surface 20 of a light guide plate. The prism sheet according to the present application not only may be used for a direct-lit backlight source, but also may be used for an edge-lit backlight source.

It should be noted that the fits 110 may be arranged freely in the above embodiments. They may be arranged evenly on the light incidence surface 11 of the substrate 1, or may be arranged unevenly on the light incidence surface 11 of the substrate 1. However, in order to adjust the light in more uniform manner, in the above embodiments, the fits 110 may be arranged evenly on the light incidence surface 11 of the substrate 1.

As an example, in the above embodiments, all of the pits are provided on the light incidence surface 11 of the substrate 1 in hexagonal close-packed arrangement or in square arrangement. And a distance between central axes of adjacent pits is 0.005 mm to 0.1 mm. The respective fits provided in such arrangement not only can achieve good uniformity of fits, but also can achieve suitable density of the fits 110 arranged on the light incidence surface 11 of the substrate 1. It will not degrade the capability of adjusting the light by the prism sheet due to less distribution of the fits 110 on the light incidence surface 11 of the substrate 1.

An embodiment of the present application also provides a method for producing the prism sheet as described in the above technical solutions. The method includes: providing a die with a plurality of protrusions 31 and forming a plurality of pits on a substrate by using the protrusions 31 on the die to finish production of the prism sheet. As an example, the plurality of protrusions 31 may have shapes complementary to the shapes of the fits on the light incidence surface of the prism sheet, as shown in FIG. 13.

In contrast to the prior art, the method for producing the prism sheet provided by the embodiments of the present application have the same advantageous effects as the prism sheet provided by the above embodiments.

It should be noted that in the above embodiments, the die may be selected depending on materials of the substrate 1 and the production process. The method for producing the prism sheet can be exemplified below, but it is not limited to this.

As an example, when the die is a roller 30, the plurality of protrusions 31 are provided on a surface of the roller; and the step of forming the plurality of pits 110 on the substrate 1 by using the protrusions on the die includes:

forming a photosensitive resist coating 15 on a first side (it may be used as the light incidence surface 11) of the substrate 1;

driving the roller 30 to roll over the photosensitive resist coating 15 to transfer a pattern formed by the protrusions on the roller 30 onto the photosensitive resist coating 15 to form a plurality of pits 110 in the photosensitive resist coating 15; and

photo curing the photosensitive resist coating 15 formed with the plurality of pits 110 to form the prism sheet.

The above substrate 1 and photosensitive resist have various types, for example, the substrate 1 may be selected from the conventional PET thin film, i.e., polyester thin film having a thickness of 0.3 mm to 1 mm; the photosensitive resist coating may be ultraviolet photosensitive resist having a thickness of 0.005 mm to 0.1 mm.

As an example, when the die is a die 30′ used in an injection molding process (as shown in FIG. 14), the step of forming the plurality of pits 110 on the substrate 1 by using the protrusions 31 on the die includes:

forming the prism sheet in the die by injection molding process, in particular, applying heat and pressure to the material for producing the prism sheet to melt it and then injecting the melted material into the die and cooling it to obtain the substrate 1 having a surface on which the fits 110 are formed, that is, the prism sheet.

As an example, when the die is a die that can be heated, the step of forming the plurality of pits 110 on the substrate 1 by using the protrusions on the die includes:

heating the die to a target temperature and placing the substrate 1 into the die to form the pits 110 on locations of the substrate 1 which contact with the protrusions, so as to obtain the prism sheet.

An embodiment of the present application also provides a backlight module including the prism sheet provided by the above technical solutions.

In contrast to the prior art, the backlight module provided by the embodiments of the present application have the same advantageous effects as the prism sheet provided by the above embodiments. In addition, the backlight module may be a direct-lit backlight module, or an edge-lit backlight module.

An embodiment of the present application also provides a VR display apparatus including the backlight module provided by the above technical solutions.

In contrast to the prior art, the VR display apparatus provided by the embodiments of the present application have the same advantageous effects as the prism sheet provided by the above embodiments.

In addition, the VR display apparatus provided by the above embodiments have various types, in particular, relates to a VR wearable device. The VR wearable device is typically implemented in a form of VR wearable glasses. Such VR wearable glasses include a display device and lenses arranged between a display screen and human's eyes. The display device is composed of a backlight module and the display screen and the backlight module may be a direct-lit backlight module, or an edge-lit backlight module.

Taking the edge-lit backlight module as an example of the backlight module, the conventional edge-lit backlight module provides a backlight which does not have directivity to the display screen. In this way, after the light from the image displayed on the display device reaches the eyes of a user, the image seen by the user tends to be distorted. Thus, a lens which may adjust the light from the image is typically provided between the display device and the eyes, so as to reduce the distortion of the image seen by the user. And the distortion of the image seen by the user will not be reduced sufficiently unless the lens has an enough large area with respect to the area of the display screen. It can be seen that the volume of the VR wearable glasses depends on the area of the lens and the lens must have a sufficiently large area; otherwise, it will not satisfy the requirements.

In contrast, after the prism sheet is provided between an optical film and the light guide plate of the conventional edge-lit backlight module, as the prism sheet may control the light exit direction by the orientation in which the pit 110 is shrunk gradually such that the edge-lit backlight module can provide a backlight having good directionality to a display screen, so as to adjust the exit light from an image displayed on the display screen. Thus, even if the lens which can adjust the exit light from the image is not arranged between the display device and the eyes of the user, the possibility that the image seen by the user produces distortion may also be relatively low (in contrast to the conventional edge-lit backlight module). In order to further reduce the distortion of the image seen by the user, the lens may be arranged between the display device and the eyes. However, as the exit light from the image displayed on the display device has been adjusted by the backlight module in the display device, it is not required that the area of the lens is very large with respect to the area of the display screen. Thus, the requirements will be satisfied without greatly increasing the volume of the VR wearable glasses even though the volume of the VR wearable glasses is affected by the area of the lens.

From the above analysis, it can be known that in the VR wearable glasses, the backlight module of the display device provided with the above prism sheet can make the VR wearable glasses compact for easy wearing and can reduce the distortion of the image to provide better immersive experiences for the user.

In the above description of embodiments, the specific features, structures, materials or characteristics may be combined suitably in any one or more embodiments or examples.

Only some exemplified embodiments of the present disclosure are explained in the above description. However, the scope of the present disclosure is not limited to those. Any variants or alternations that the skilled person in the art can easily envisage within the technical range of the present disclosure should fall within the scope of the present disclosure. Therefore, the scope of the present disclosure should be defined by the scope of the appended claims.

1. A prism sheet, comprising a substrate which has a light incidence surface and a light exit surface, the light incidence surface and the light exit surface being respectively arranged on a first side and a second side of the substrate opposed to each other, wherein a plurality of pits are provided on the light incidence surface and spaced apart from each other, and each of the pits comprises an opening portion, a bottom portion and an inclined wall portion connecting the opening portion with the bottom portion, an opening which is formed by the opening portion has an area greater than the area of the bottom portion of the pit.

2. The prism sheet according to claim 1, wherein a plane in which the opening portion of the pit is arranged is at an angle α of 10 degrees to 70 degrees with respect to the inclined wall portion.

3. The prism sheet according to claim 1, wherein the opening portion has a shape of circle or polygon.

4. The prism sheet according to claim 1, wherein the opening portion has a shape of circle and each pit is a circular cone-shaped pit or a circular truncated cone-shaped pit.

5. The prism sheet according to claim 4, wherein the opening portion of the circular cone-shaped pit has a diameter of 0.005 mm to 0.1 mm and the circular cone-shaped pit has a depth of 0.005 mm to 0.1 mm; or
the opening portion of the circular truncated cone-shaped pit has a diameter of 0.01 mm to 0.1 mm and the circular truncated cone-shaped pit has a bottom diameter of 0.005 mm to 0.09 mm and a depth of 0.005 mm to 0.1 mm.

6. The prism sheet according to claim 1, wherein the opening portion has a shape of polygon and each pit is a pyramid-shaped pit.

7. The prism sheet according to claim 6, wherein the pyramid-shaped pit is a regular pyramid-shaped pit; the opening portion of the regular pyramid-shaped pit has a side length of 0.005 mm to 0.1 mm and the regular pyramid-shaped pit has a depth of 0.00 mm to 0.1 mm.

8. The prism sheet according to claim 1, wherein a distance between central axes of adjacent pits is 0.005 mm to 0.1 mm.

9. The prism sheet according to claim 1, wherein all of the pits are provided on the light incidence surface of the substrate in hexagonal close-packed arrangement or in square arrangement.

10. A method for producing the prism sheet according to claim 1, the method comprising:
providing a die with a plurality of protrusions and forming a plurality of pits on a substrate by using the protrusions on the die to finish production of the prism sheet.

11. The method according to claim 10, wherein the die is a roller and the plurality of protrusions are provided on a surface of the roller, and
the forming the plurality of pits on the substrate by using the protrusions on the die comprises:
forming a photosensitive resist coating on a first side of the substrate;
driving the roller to roll over the photosensitive resist coating to transfer a pattern formed by the protrusions on the roller onto the photosensitive resist coating to form the plurality of pits in the photosensitive resist coating; and
photo curing the photosensitive resist coating formed with the plurality of pits to form the prism sheet.

12. The method according to claim 10, wherein the forming the plurality of pits on the substrate by using the protrusions on the die comprises:
forming the prism sheet in the die by an injection molding process; or
heating the die to a target temperature and placing the substrate into the die to form the pits on locations of the substrate which contact with the protrusions, so as to obtain the prism sheet.

13. A backlight module comprising the prism sheet according to claim 1.

14. A VR display apparatus comprising the backlight module according to claim 13.

15. The backlight module according to claim 13, wherein a plane in which the opening portion of the put is arranged is at an angle α of 10 degrees to 70 degrees with respect to the inclined wall portion.

16. The backlight module according to claim 13, wherein the opening portion has a shape of circle or polygon.

17. The backlight module according to claim 13, wherein the opening portion has a shape of circle or polygon.

18. The backlight module according to claim 17, wherein the opening portion of the circular cone-shaped pit has a diameter of 0.005 mm to 0.1 mm and the circular cone-shaped pit has a depth of 0.005 mm to 0.1 mm; or
the opening portion of the circular truncated cone-shaped pit has a diameter of 0.01 mm to 0.1 mm and the circular truncated cone-shaped pit has a bottom diameter of 0.005 mm to 0.09 mm and a depth of 0.005 mm to 0.1 mm.

19. The backlight module according to claim 13, wherein the opening portion has a shape of polygon and each pit is a pyramid-shaped pit.

20. The backlight module according to claim 19, wherein the pyramid-shaped pit is a regular pyramid-shaped pit; the opening portion of the regular pyramid-shaped pit has a side length of 0.005 mm to 0.1 mm and the regular pyramid-shaped pit has a depth of 0.005 mm to 0.1 mm.
